(19) United States
(12) Patent Application Publication
(10) Pub. No.: US 2010/0309997 A1
(43) Pub. Date: Dec. 9, 2010

(54) RADIO COMMUNICATION TERMINAL DEVICE, RADIO COMMUNICATION BASE STATION DEVICE, AND CQI FEEDBACK METHOD

(75) Inventors: Ryohei Kimura, Kanagawa (JP); Seigo Nakao, Kanagawa (JP); Masayuki Hoshino, Kanagawa (JP); Kenichi Miyoshi, Kanagawa (JP); Katsuhiko Hiramatsu, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/745,461

(22) PCT Filed: Dec. 9, 2008
(86) PCT No.: PCT/JP2008/003671

§ 371 Date: May 28, 2010

(30) Foreign Application Priority Data
Dec. 10, 2007 (JP) 2007-318453

(51) Int. Cl. H04L 27/28

(52) U.S. Cl. 375/260

(57) ABSTRACT

It is possible to provide a radio communication terminal device, a radio communication base station device, and a CQI feedback method which can improve the CQI reproducibility while reducing the feedback overhead. A terminal channel judgment unit judges whether a local terminal is a TU terminal or a LOS terminal. A feedback CQI decision unit selects a Best-M report if the local terminal is the TU terminal, and selects a DCT report if the local terminal is the LOS terminal. The feedback CQI decision unit feeds back the CQI by using the selected report method.

### TECHNICAL FIELD

The present invention relates to a wireless communication terminal apparatus, wireless communication base station apparatus and CQI feedback method.

### BACKGROUND ART

Frequency scheduling (e.g. multi-user scheduling) is one technique of improving downlink cell throughput in 3GPP LTE. Terminals feed back CQI's (Channel Quality Indicators) determined based on the SINR (Signal to Interference and Noise Ratio) per RB (Resource Block), to a base station, and the base station allocates communication resources to the terminals using these CQI's.

The base station preferentially allocates communication resources to terminals that feed back higher CQI's. When the number of terminals increases, the number of terminals that feed back high CQI's also increases, so that the cell throughput (such as the peak data rate and frequency use efficiency) improves. At present, among the CQI feedback methods that are studied in 3GPP LTE, a best-M report is the prime candidate.

FIG. 1 shows an outline of the best-M report. With the best-M report, the RB's of the top M CQI levels are selected from the CQIᵢ (1≦i≦N_{RB}) of all RB's (i.e. RBᵢ, where 1≦i≦N_{RB}), and the CQIᵢ^{(j)} (1≦j≦M) corresponding to these RB's and their average CQI are fed back. For example, in the case of 10 MHz transmission (N_{RB}=50), M=5 and the CQI level 32, the number of CQI feedback bits in the best-M report, N_{bestM}, is given by the following equation.

(Equation 1)

N_{bestM}=5M+log₂(_{N}_{_{RB}}C_{M})+5=25+21+5=51bit [1]

There is also a DCT (Discrete Cosine Transform) report for feeding back direct current components and (M−1) amplitude components of lower frequency components, from DCT transform results of CQI; (1≦i≦N_{RB}). FIG. 2 shows an outline of the DCT report. The number of CQI feedback bits in the DCT report, N_{DCT}, is given by the following equation.

(Equation 2)

N_{DCT}=D+5(M−1)=5+20=25bit [2]

Here, D is 5 and represents the number of representation (quantized) bits of DC components.

Thus, with the best-M report, the feedback overhead is high (52 bits per 10 MHz), so that it is possible to improve the reconstructibility of CQI's. On the other hand, with the DCT report, although it is possible to suppress the feedback overhead (25 bits per 10 MHz), the reconstructibility of CQI's becomes poor. That is, there is a tradeoff relationship between feedback overhead and CQI reconstructibility.

Hereinafter, a terminal that is present in a channel environment of high frequency selectivity will be referred to as “TU terminal,” and a terminal that is present in a channel environment of low frequency selectivity (which is nearly non-frequency-selectivity) will be referred to as “LOS terminal.”

Non-Patent Document 1: 3GPP, R1-062954, LG Electronics, “Analysis on DCT based CQI reporting Scheme”, RAN1 #46-bis, Seoul, Oct. 9-13, 2006

### DISCLOSURE OF INVENTION

### Problems to be Solved by the Invention

Up till now, regardless of the channel conditions of terminals, an arbitrary terminal feeds back a CQI by a best-M report. However, provided that the best-M report is designed to represent the CQI's of TU terminals accurately, if LOS terminals use the best-M report, their CQI's would be represented using excessive resources (bits).

It is therefore an object of the present invention to provide a wireless communication terminal apparatus, wireless communication base station apparatus and CQI feedback method for reducing feedback overhead and improving the reconstructibility of CQI's.

### Means for Solving the Problem

The wireless communication terminal apparatus of the present invention employs a configuration having: a channel detecting section that detects whether a current channel environment is a channel environment of high frequency selectivity or a channel environment of low frequency selectivity; a feedback channel quality indicator determining section that: in the channel environment of high frequency selectivity, selects a best-M report for feeding back channel quality indicators of top M channel quality indicator levels and an average channel quality indicator of all channel quality indicator levels; in the channel environment of low frequency selectivity, selects a discrete cosine transform report for feeding back a direct current component and (M−1) amplitude components of lower frequency components, in discrete cosine transform conversion results of a channel quality indicator; and determines a channel quality indicator to feed back according to a selected report method; and a transmitting section that feeds back the determined channel quality indicator to a wireless communication base station apparatus.

The wireless communication base station apparatus of the present invention employs a configuration having: a receiving section that receives a first channel quality indicator corresponding to a channel formed using a first cyclic delay diversity, by a discrete cosine transform report for feeding back M amplitude components of lower frequency components in discrete cosine transform conversion results of channel quality indicators; and a reconstructing section that reconstructs a second channel quality indicator corresponding to a channel formed using a second cyclic delay diversity different from the first cyclic delay diversity, based on the first channel quality indicator.

The CQI feedback method of the present invention includes: a channel detecting step of detecting whether a current channel environment is a channel environment of high frequency selectivity or a channel environment of low frequency selectivity; and a feedback channel quality indicator determining step of: in the channel environment of high frequency selectivity, selecting a best-M report for feeding back channel quality indicators of top M channel quality indicator levels and an average channel quality indicator of all channel quality indicator levels; in the channel environment of low frequency selectivity, selecting a discrete cosine transform report for feeding back a direct current component and (M−1) amplitude components of lower frequency components, in discrete cosine transform conversion results of channel quality indicators; and determining a channel quality indicator to feed back according to a selected report method.

### ADVANTAGEOUS EFFECT OF THE INVENTION

According to the present invention, it is possible to reduce feedback overhead and improve the reconstructibility of CQI's.

### BRIEF DESCRIPTION OF DRAWINGS

FIG. 1 shows an outline of a best-M report;

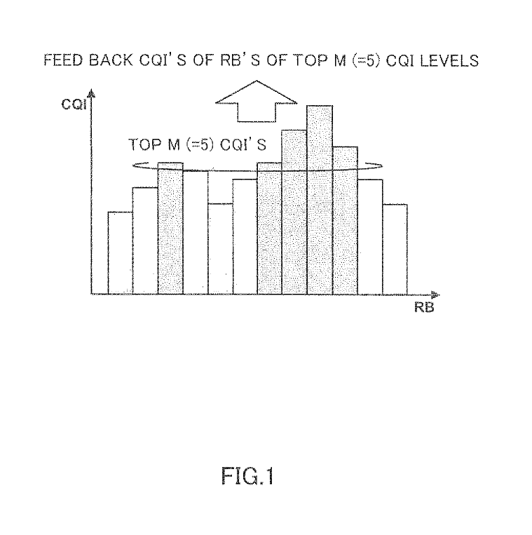

FIG. 2 shows an outline of a DCT report;

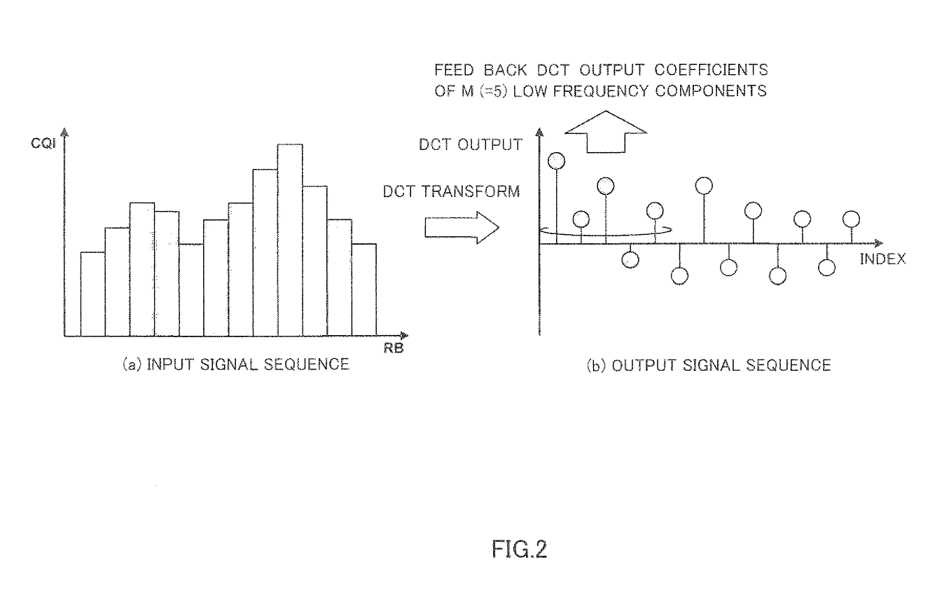

FIG. 3 is a block diagram showing the configuration of a terminal according to Embodiment 1 of the present invention;

FIG. 4 is a flowchart showing the processing steps of CQI value estimation;

FIG. 5 illustrates a CDD synthesis channel;

FIG. 6 is a flowchart showing the processing steps of terminal channel detection;

FIG. 7 shows CQI feedback formants according to Embodiment 1 of the present invention;

FIG. 8 is a block diagram showing the configuration of a base station according to Embodiment 1 of the present invention;

FIG. 9 is a block diagram showing the configuration of a terminal according to Embodiment 2 of the present invention;

FIG. 10 illustrates a synthesis channel of CDD's of different phases;

FIG. 11 illustrates a synthesis channel of CDD's of different angular velocities;

FIG. 12 shows CQI feedback formats according to Embodiment 2 of the present invention;

FIG. 13 shows a state where DC components given as a result of DCT transform of CQI's are substantially the same;

FIG. 14 shows DCT output results of CQI's formed by two CCD matrixes of different phases;

FIG. 15 shows DCT output results of CQI's formed by two CDD matrixes of different angular velocities;

FIG. 16 is a block diagram showing the configuration of a base station according to Embodiment 2 of the present invention;

FIG. 17 shows a state where RB's are allocated to LOS terminals and TU terminal; and

FIG. 18 is a block diagram showing the configuration of a base station according to Embodiment 3 of the present invention.

### BEST MODE FOR CARRYING OUT THE INVENTION

Embodiments of the present invention will be explained below in detail with reference to the accompanying drawings. Here, in the embodiments, the same components having the same functions will be assigned the same reference numerals and overlapping explanations will be omitted.

### Embodiment 1

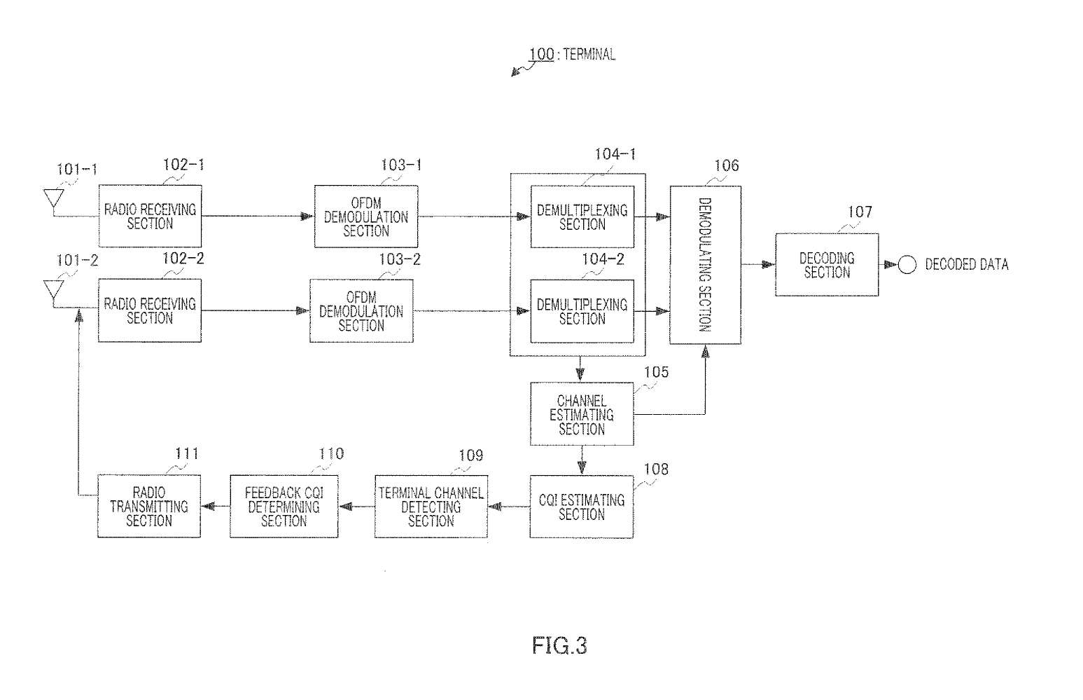

The configuration of terminal 100 according to Embodiment 1 of the present invention will be explained using FIG. 3. In FIG. 3, radio receiving sections 102-1 and 102-2 receive RF (Radio Frequency) signals transmitted from a base station, which will be described later, via antennas 101-1 and 101-2, and convert the RF signals into OFDM baseband signals by performing processing such as down-conversion. These OFDM baseband signals are outputted to OFDM demodulating sections 103-1 and 103-2.

OFDM demodulating sections 103-1 and 103-2 remove the CP's (Cyclic Prefixes) from the OFDM baseband signals outputted form radio receiving sections 102-1 and 102-2, and transform the time domain signals into frequency domain signals by performing fast Fourier transform processing of the OFDM baseband signals without CF's. These frequency domain signals are outputted to demultiplexing sections 104-1 and 104-2.

Demultiplexing sections 104-1 and 104-2 demultiplex the frequency domain signals outputted from OFDM demodulating sections 103-1 and 103-2 into the data signals and the common reference signals, output the data signals to demodulating section 106 and output the common reference signals to channel estimating section 105.

Channel estimating section 105 calculates channel estimation values Ĥ_{k,j} between the transmission antennas of the base station and the receiving antennas of terminal 100, using the common reference signals outputted from demultiplexing sections 104-1 and 104-2, and calculates a CDD (Cyclic Delay Diversity) synthesis channel estimation value Ĥₖ as shown in the following equation, using the calculated channel estimation values Ĥ_{k,j} and the number of cyclic delay shift samples τᵢ (1≦i≦2).

$$\begin{matrix}( Equation 3 ) & \\ {\hat{H}}_{k} = {\hat{H}}_{k , 1} {e}^{j \frac{2 π}{N} {τ}_{1} k} + {\hat{H}}_{k , 2} {e}^{j \frac{2 π}{N} {τ}_{2} k} & [ 3 ]\end{matrix}$$

Here, k and i represent the subcarrier number and the transmission antenna number, respectively. The calculated CDD synthesis channel estimation value Ĥ_{I}, is outputted to demodulating section 106 and CQI estimating section 108.

Demodulating section 106 demodulates the data signals outputted from demultiplexing sections 104-1 and 104-2 using the channel estimation value outputted form channel estimating section 105, and generates soft decision bits. This generated soft decision bits are outputted to decoding section 107.

Decoding section 107 performs channel decoding of the soft decision bits outputted from demodulating section 106, decodes the information data sequence and outputs the decoded data.

CQI estimating section 108 estimates the CQI values of RB's using the channel estimation value Ĥₖ outputted from channel estimating section 105, and outputs the results to terminal channel detecting section 109. Here, the CQI value estimation will be described later in detail.

Terminal channel detecting section 109 detects the terminal channel conditions, that is, terminal channel detecting section 109 detects whether the subject terminal is a TU terminal or an LOS terminal, using the CQI values of RB's outputted from CQI estimating section 108, and outputs the detection result to feedback CQI determining section 110. Here, the terminal channel detection will be described later in detail.

Feedback CQI determining section 110 generates CQI feedback information based on the terminal channel detection result outputted from terminal channel detecting section 109, and outputs the CQI feedback information to radio transmitting section 111. Here, the feedback CQI determination will be described later in detail.

Radio transmitting section 111 performs processing such as up-conversion on the CQI feedback information outputted from feedback CQI determining section 110 to convert that information into an RF signal, and transmits the RF signal to a base station which will be described later.

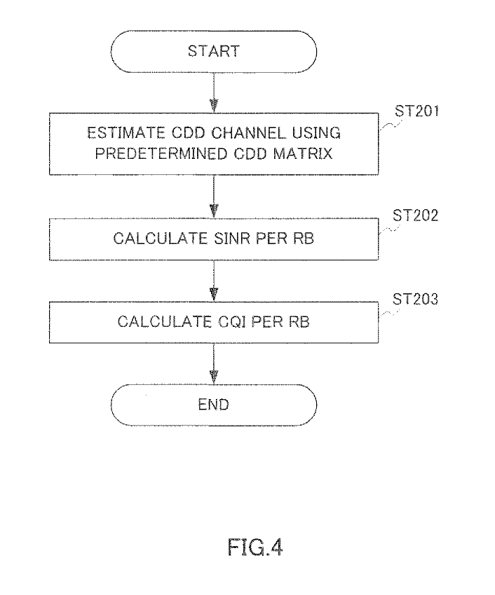

Here, the CQI value estimating processing in above CQI estimating section 108 will be explained in detail. FIG. 4 is a flowchart showing the processing steps of CQI value estimation. In step (hereinafter abbreviated to “ST”) 201 in FIG. 4, CDD synthesis channel estimation value Ĥₖ is calculated as shown in the following equation, using the CDD matrix and channel estimation values Ĥ_{k,j}, which are used in common between a best-M report and a DCT report.

$$\begin{matrix}( Equation 4 ) & \\ \begin{matrix}{\hat{H}}_{k} = [ \begin{matrix}{\hat{H}}_{k , 1} & {\hat{H}}_{k , 2} ]\end{matrix} [ \begin{matrix}{e}^{j \frac{2 π}{N} {τ}_{1} k} & 0 \\ 0 & {e}^{j \frac{2 π}{N} {τ}_{2} k}\end{matrix} ] \\ = {\hat{H}}_{k , 1} {e}^{j \frac{2 π}{N} {τ}_{1} k} + {\hat{H}}_{k , 2} {e}^{j \frac{2 π}{N} {τ}_{2} k}\end{matrix} & [ 4 ]\end{matrix}$$

Here, the C-CDD matrix is defined as follows.

$$\begin{matrix}( Equation 5 ) & \\ C - CDD = [ \begin{matrix}{e}^{j \frac{2 π}{N} {τ}_{1} k} & 0 \\ 0 & {e}^{j \frac{2 π}{N} {τ}_{2} k}\end{matrix} ] & [ 5 ]\end{matrix}$$

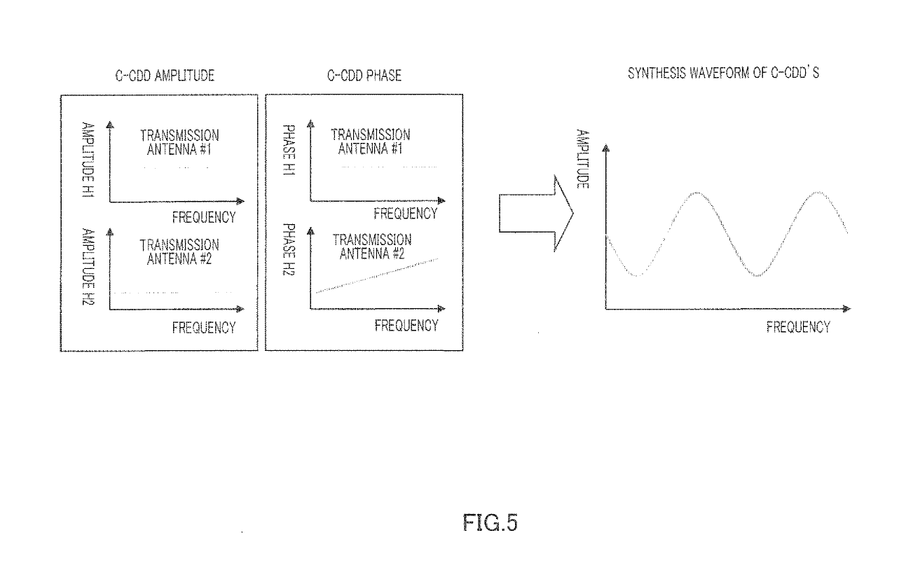

For a reference, a CDD synthesis channel will be explained using FIG. 5. As shown in this figure, the amplitude of C-CDD is fixed in amplitude H1 in one transmission antenna (transmission antenna #1) regardless of the frequency, or fixed in amplitude H2 (<H1) in the other transmission antenna (transmission antenna #2) regardless of the frequency. Also, the phase of C-CDD is fixed in phase H1 in transmission antenna #1 regardless of the frequency, while phase H2 increases when the frequency increases. When signals having such amplitudes and phases are transmitted from transmission antennas #1 and #2, a synthesis waveform is formed as shown in FIG. 5.

Referring back to FIG. 4, in ST 202, the SINR of each RB is calculated. To be more specific, first, signal power Sₖ of subcarrier k is determined as shown in the following equation.

(Equation 6)

Sₖ=|Ĥₖ|² [6]

Here, signal power Sⱼ⁽ⁿ⁾ of RB number n is defined as shown in the following equation.

(Equation 7)

Sⱼ⁽ⁿ⁾=|S_{N}_{_{rb}}_{·(n-1)+j}|² [7]

Here, N_{rb} represents the number of subcarriers per RB. Also, average SINRₙ in RB number n is calculated as shown in the following equation. Here, σ² represents noise power.

$$\begin{matrix}( Equation 8 ) & \\ {SINR}_{n} = \frac{{\sum }_{j = 1}^{{N}_{rb}} {S}_{j}^{( n )} / RB}{2 {σ}^{2}} & [ 8 ]\end{matrix}$$

In ST 203, CQIₙ is determined on a per RB basis from SINRₙ calculated in ST 202, using a mapping table. This mapping table associates CQIₙ with SINRₙ per predetermined range. That is, it is possible to determine CQIₙ uniquely from SINRₙ.

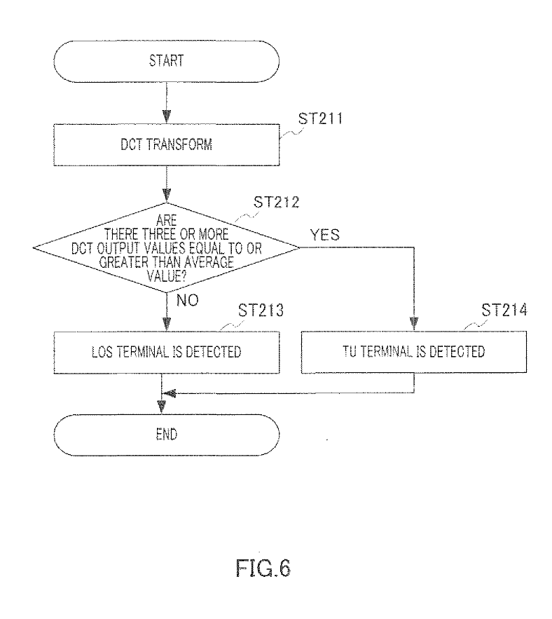

Next, the terminal channel detection in above terminal channel detecting section 109 will be explained in detail. FIG. 6 is a flowchart showing the processing steps of terminal channel detection. In ST 211 in FIG. 6, N_{RB} CQI sequences are subjected to DCT transform and converted to N_{RB} coefficients.

In ST 212, using the average value of the absolute values of DCT output values in ST 211 as a threshold, a threshold decision is performed for each DCT output value, and the number of DCT output values greater than the threshold is counted. If the count result N_{d} is equal to or less than 2 (“NO” in ST 212), an LOS terminal is detected in ST 213, and, if the count result N_{d} is equal to or greater than 3 (“YES” in ST 212), a TU terminal is detected in ST 214.

Next, the feedback CQI determination in feedback CQI determining section 110 will be explained in detail. If a detection result in terminal channel detecting section 109 indicates a TU terminal, feedback CQI determining section 110 selects a best-M report and selects CQIₘ^{(s)} (1≦m≦M) of the top M CQI levels from CQIₙ (1≦n≦N_{RB}), and RBₘ (1≦m≦M) corresponding to the selected CQIₘ^{(s)}. Further, if CQI feedback information indicates a TU terminal, feedback CQI determining section 110 adds TU/LOS terminal identification flag “0” to the CQI feedback information.

By contrast, if a detection result from terminal channel detecting section 109 indicates an LOS terminal, feedback CQI determining section 110 selects a DCT report and selects direct current components and (M−1) amplitude components of lower frequency components from DCT transform results of CQIₙ (1≦n≦N_{RB}). Further, if CQI feedback information indicates an LOS terminal, feedback CQI determining section 110 adds TU/LOS terminal identification flag “1” to the CQI feedback information.

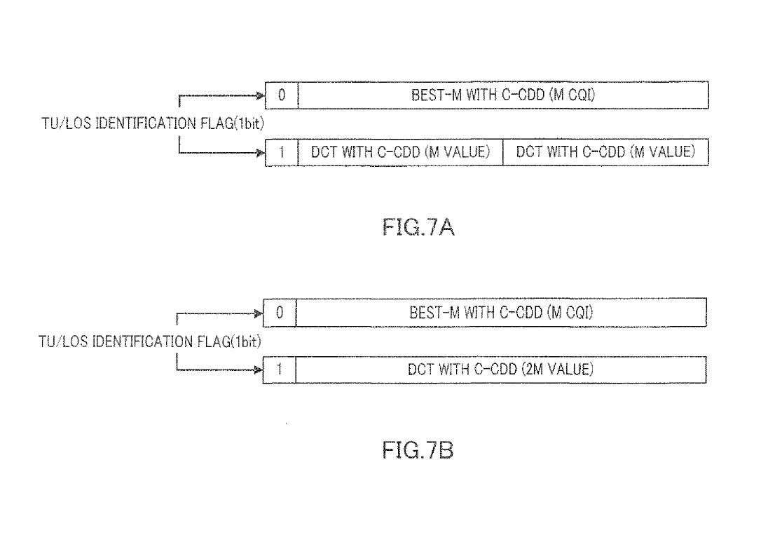

Thus, an LOS terminal reduces feedback overhead by selecting a DCT report, producing available resources in CQI feedback formats. Here, the formats shown in FIG. 7A and FIG. 7B are possible. The CQI feedback format for a DCT report shown in FIG. 7A represents a format formed with M DCT output values subjected to repetition processing, thereby improving the receiving performance for M DCT output values. Also, the CQI feedback format for a DCT report shown in FIG. 7B represents a format formed with double-M DCT output values (i.e. 2M DCT output values), thereby improving the reconstructibility of CQI values.

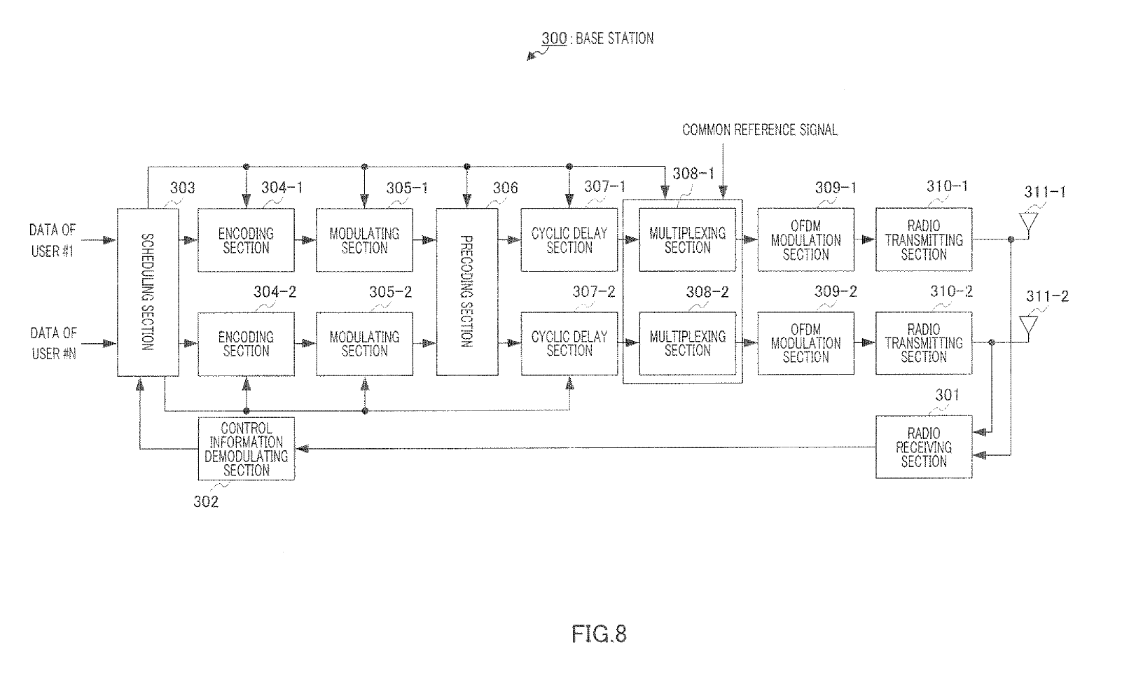

Next, the configuration of base station 300 according to Embodiment 1 of the present invention will be explained using FIG. 8. In FIG. 8, radio receiving section 301 receives RF signals transmitted from a terminal via antennas 311-1 and 311-2, and converts the RF signals into OFDM baseband signals by performing processing such as down-conversion. These OFDM baseband signals are outputted to control information demodulating section 302.

Control information demodulating section 302 demodulates the OFDM baseband signals outputted from radio receiving section 301, and acquires and outputs CQI feedback information, CDD information and terminal channel conditions, to scheduling section 303.

Scheduling section 303 allocates resources based on the CQ1 feedback information outputted from control information demodulating section 302, and outputs user data to encoding sections 304-1 and 304-2 according to the allocated resources. Further, scheduling section 303 outputs a coding rate to encoding section 304-1 and 304-2, modulation scheme to modulating sections 305-1 and 305-2, PMI (Precoding Matrix Indicator) representing a precoding matrix to precoding section 306, and control signal including a C-CDD matrix to cyclic delay sections 307-1 and 307-2 and multiplexing sections 308-1 and 308-2.

Encoding sections 304-1 and 304-2 perform channel coding of the user data outputted from scheduling section 303, by the coding rate included in the control signal outputted likewise from scheduling section 303, and output encoded bits to modulating sections 305-1 and 305-2.

Modulating sections 305-1 and 305-2 perform QAM (e.g. QPSK, 16QAM and 64 QAM) modulation of the encoded bits outputted from encoding sections 304-1 and 304-2, according to the modulation scheme included in the control signal outputted from scheduling section 303, and output modulation symbols to precoding section 306.

Precoding section 306 performs precoding processing of the modulation symbols outputted from modulating sections 305-1 and 305-2, based on the PMI included in the control signal outputted from scheduling section 303, and output the results to cyclic delay sections 307-1 and 307-2.

Cyclic delay sections 307-1 and 307-2 give cyclic delay shifts to the symbols outputted from precoding section 306, using the C-CDD matrix included in the control signal outputted from scheduling section 303, and output the results to multiplexing sections 308-1 and 308-2.

Multiplexing sections 308-1 and 308-2 multiplex the data signals outputted from cyclic delay sections 307-1 and 307-2, the control signal outputted from scheduling section 303 and a common reference signal received as input, and output the results to OFDM modulation sections 309-1 and 309-2.

OFDM modulation sections 309-1 and 309-2 convert frequency domain signals into time domain signals by applying an inverse fast Fourier transform to the multiplexed signals outputted from multiplexing sections 308-1 and 308-2, and add CP's to the frequency domain signals to generate OFDM signals. These generated OFDM signals are outputted to radio transmitting sections 310-1 and 310-2.

Radio transmitting sections 310-1 and 310-2 convert the OFDM signals outputted from OFDM modulation sections 309-1 and 309-2 into RF signals, and transmit these RF signals from antennas 311-1 and 311-2.

Thus, according to Embodiment 1, TU terminals select a best-M report and LOS terminals select a DCT report, so that it is possible to reduce feedback overhead and improve the reconstructibility of CQI's.

### Embodiment 2

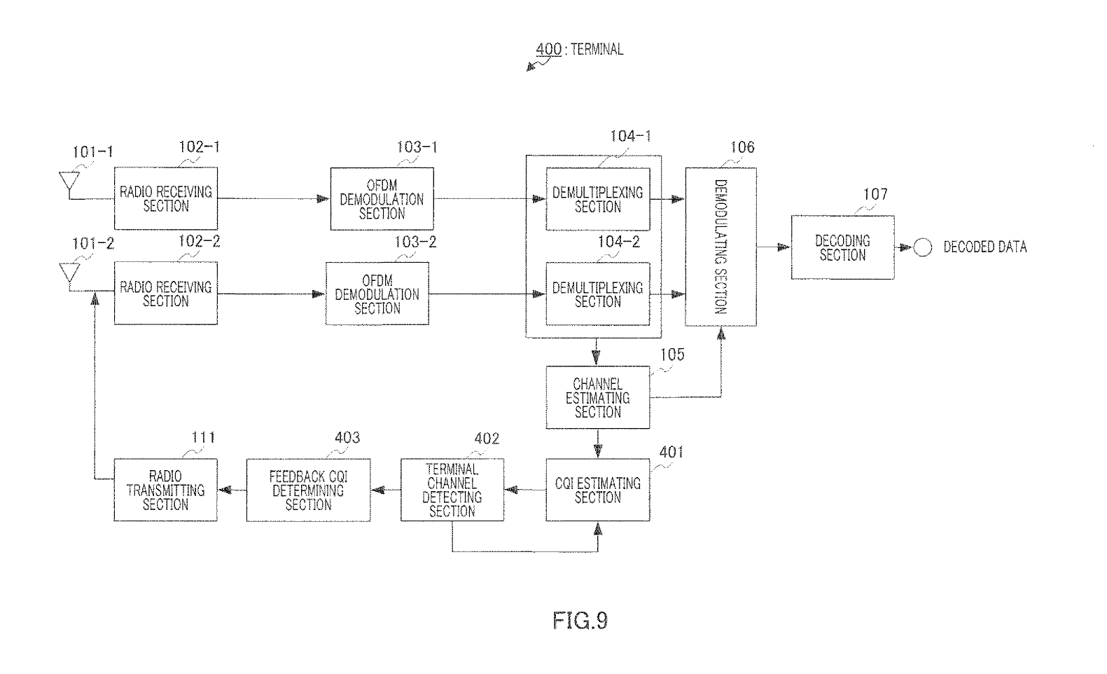

The configuration of terminal 400 according to Embodiment 2 of the present invention will be explained using FIG. 9. FIG. 9 differs from FIG. 3 in replacing CQI estimating section 108 with CQI estimating section 401, replacing terminal channel detecting section 109 with terminal channel detecting section 402 and replacing feedback CQI determining section 110 with feedback CQI determining section 403.

CQI estimating section 401 estimates the CQI values of RB's using channel estimation value Ĥₖ outputted from channel estimating section 105, and outputs the CQI values to terminal channel detecting section 402. To be more specific, CQI estimating section 401 estimates a CDD synthesis channel using a supplementary CDD (i.e. A-CDD) matrix in addition to C-CDD. There are two patterns of relationships between C-CDD and A-CDD, that is, there are two cases where a phase varies between C-CDD and A-CDD, and where an angular velocity varies between C-CDD and A-CDD. First, a case will be explained where a phase varies between C-CDD and A-CDD. The C-CDD matrix and A-CDD matrix are as shown in the following equation.

$$\begin{matrix}( Equation 9 ) & \\ \{ \begin{matrix}C - CDD = \frac{1}{\sqrt{2}} [ \begin{matrix}1 & 0 \\ 0 & {e}^{jφ k}\end{matrix} ] \\ A - CDD = \frac{1}{\sqrt{2}} [ \begin{matrix}1 & 0 \\ 0 & {e}^{j ( φ k + π )}\end{matrix} ]\end{matrix} & [ 9 ]\end{matrix}$$

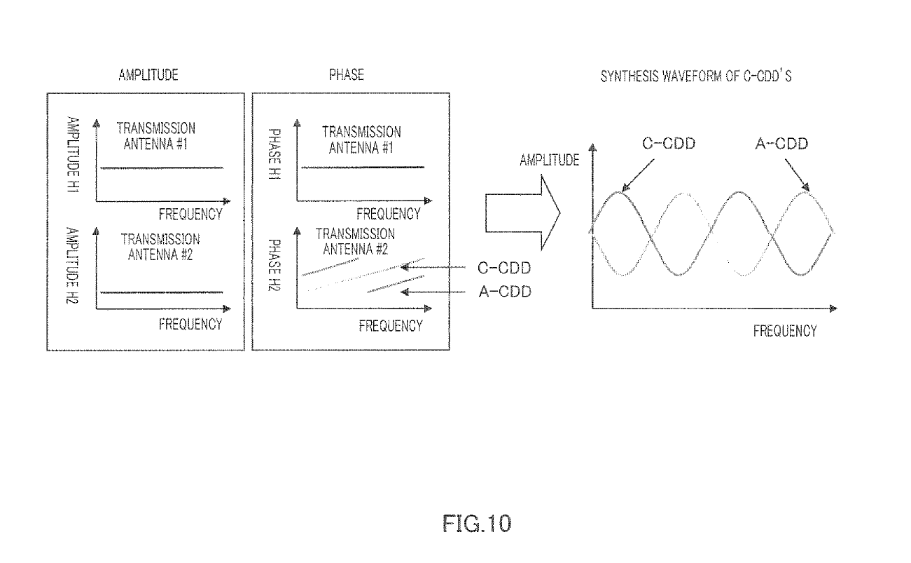

Also, as shown in FIG. 10, the amplitude of C-CDD is fixed in amplitude H1 in transmission antenna #1 regardless of the frequency, or fixed in amplitude H2 (<H1) in transmission antenna #2 regardless of the frequency. Also, the phase is fixed in phase H1 in transmission antenna #1 regardless of the frequency, and, in transmission antenna #2, the weight phase per subcarrier is inverted (i.e. shifted by π) between C-CDD and A-CDD. If signals having such amplitudes and phases are transmitted from transmission antennas #1 and #2, a synthesis waveform of C-CDD and A-CDD is formed as shown in FIG. 10.

Next, a case will be explained where an angular velocity varies between C-CDD and A-CDD. The C-CDD matrix and A-CDD matrix are as shown in the following equation.

$$\begin{matrix}( Equation 10 ) & \\ \{ \begin{matrix}C - CDD = \frac{1}{\sqrt{2}} [ \begin{matrix}1 & 0 \\ 0 & {e}^{jφ k}\end{matrix} ] \\ A - CDD = \frac{1}{\sqrt{2}} [ \begin{matrix}1 & 0 \\ 0 & {e}^{jφ k / 2}\end{matrix} ]\end{matrix} & [ 10 ]\end{matrix}$$

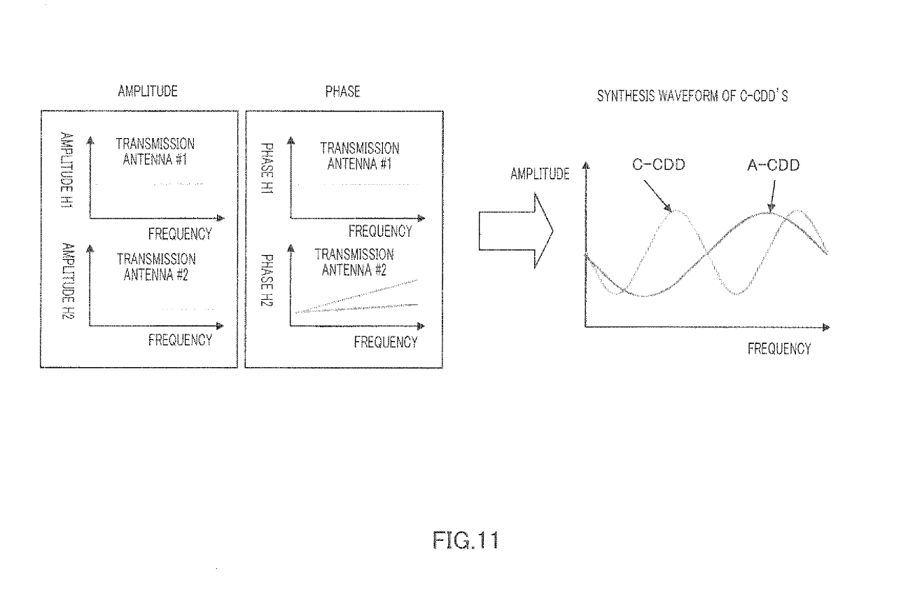

Also, as shown in FIG. 11, the amplitude of C-CDD is similar to in FIG. 10, and the phase is fixed in phase H1 in transmission antenna #1 regardless of the frequency, and, in transmission antenna #2, the angular velocity per subcarrier varies between C-CDD and A-CDD. If signals having such amplitudes and phases are transmitted from transmission antennas #1 and #2, a synthesis waveform of C-CDD and A-CDD is formed as shown in FIG. 11.

Also, if an LOS terminal is detected in terminal channel detecting section 402, CQI estimating section 401 receives a notice from terminal channel detecting section 402, calculates a DCT output corresponding to A-CDD and outputs the DCT output to terminal channel detecting section 402. Here, terminal channel detecting section 402 has already performed detection, and therefore outputs the DCT output corresponding to A-CDD outputted from CQI estimating section 401, to feedback CQI determining section 403.

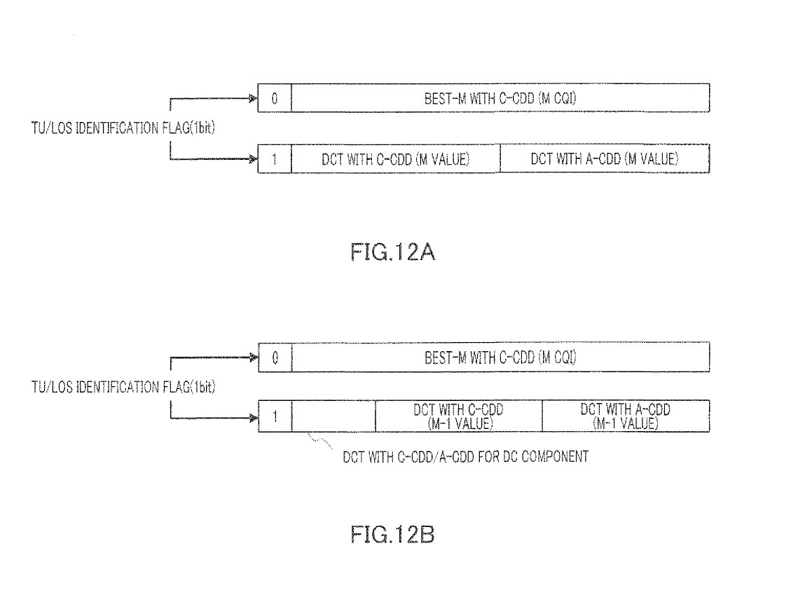

In feedback CQI determining section 403, an LOS terminal reduces feedback overhead by selecting a DCT report, producing available resources in CQI feedback formats. In the present embodiment, the formats shown in FIG. 12A and FIG. 12B are possible. The CQI feedback format for a DCT report shown in FIG. 12A represents a format including M DCT output values of C-CDD and M DCT output values of A-CDD.

Also, the CQI feedback format for a DCT report shown in FIG. 12B represents a format including (M−1) DCT output values of C-CDD and (M−1) DCT output values of A-CDD in addition to a DC component shared between C-CDD and A-CDD. The DCT output values of CQI's formed by two CDD matrixes of different phases or different angular velocities are substantially the same between these two CDD matrixes.

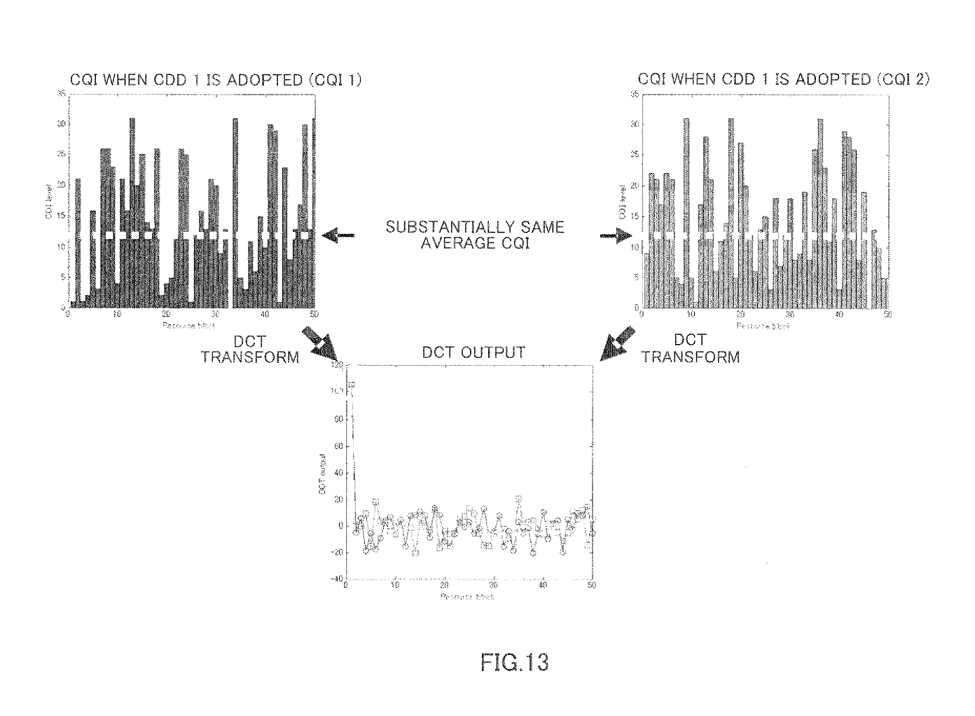

Here, a case will be explained with FIG. 13, where DC components given as a result of DCT transform of CQI's are substantially the same, FIG. 13 shows DCT output results of channels having the same average reception power (i.e. CQI level). When the average reception power (or average CQI) is substantially the same throughout the entire band, DC components given as a result of DCT transform have substantially the same values.

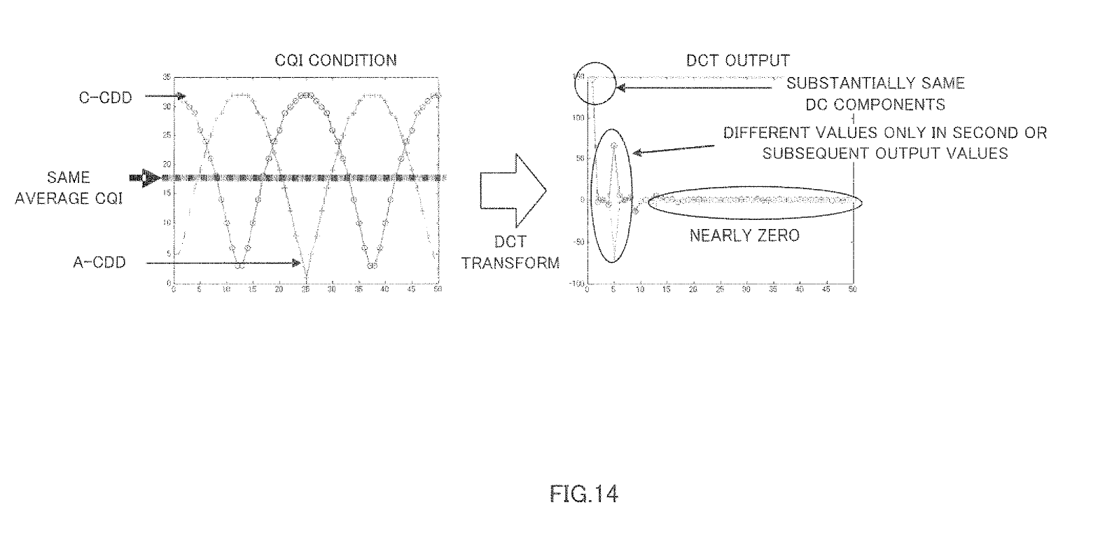

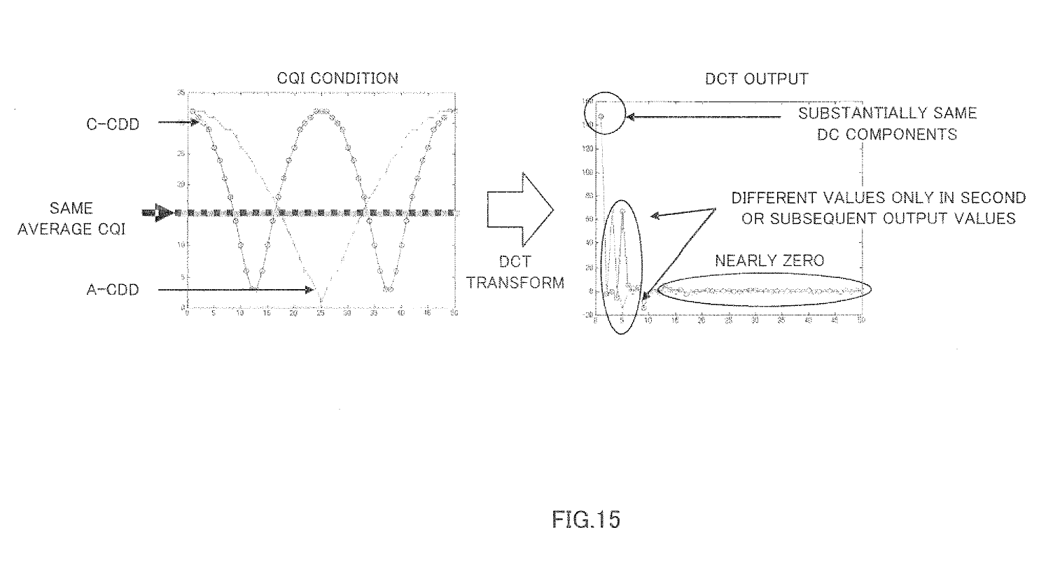

By multiplying the same propagation channel by CDD matrixes of two different phases or angular velocities, the average reception power is substantially the same through the entire band. FIG. 14 shows DCT output results of CQI's formed by two CDD matrixes of different phases, and FIG. 15 shows DCT output results of CQI's formed by two CDD matrixes of different angular velocities. As clear from FIG. 14 and FIG. 15, the average value of A-CQI's and the average value of C-CQI's are substantially the same, so that the DC components with DCT output values of CQI's formed by two CDD matrixes of different phases or angular velocities have substantially the same values. Therefore, when a plurality of channel CQI's between which the average reception power difference stays within a predetermined range (here, DCT output results of A-CQI's and C-CQI's), are fed back simultaneously, it is possible to share DC components.

By this means, it is possible to reduce the number of feedback bits representing DC components. Also, DC components have higher values than other DCT output components, so that the reduction effect is significant.

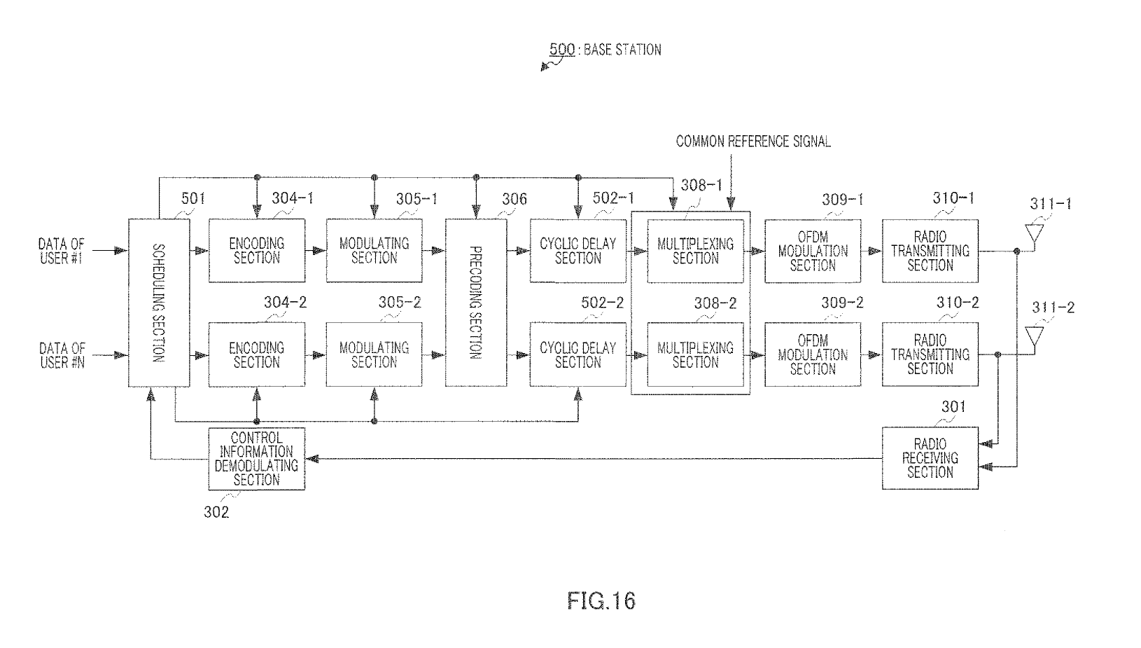

Next, the configuration of base station 500 according to Embodiment 2 of the present invention will be explained using FIG. 16. FIG. 16 differs from FIG. 8 in replacing scheduling section 303 with scheduling section 501 and replacing cyclic delay sections 307-1 and 307-2 with cyclic delay sections 502-1 and 502-2.

Scheduling section 501 allocates resources based on CQI feedback information outputted from a control information demodulating section, and outputs user data to encoding sections 304-1 and 304-2 according to the allocated resources. Further, scheduling section 501 selects the resources to allocate to an LOS terminal, from CQI's respectively corresponding to C-CDD and A-CDD (referred to as “C-CQI” and “A-CQI”).

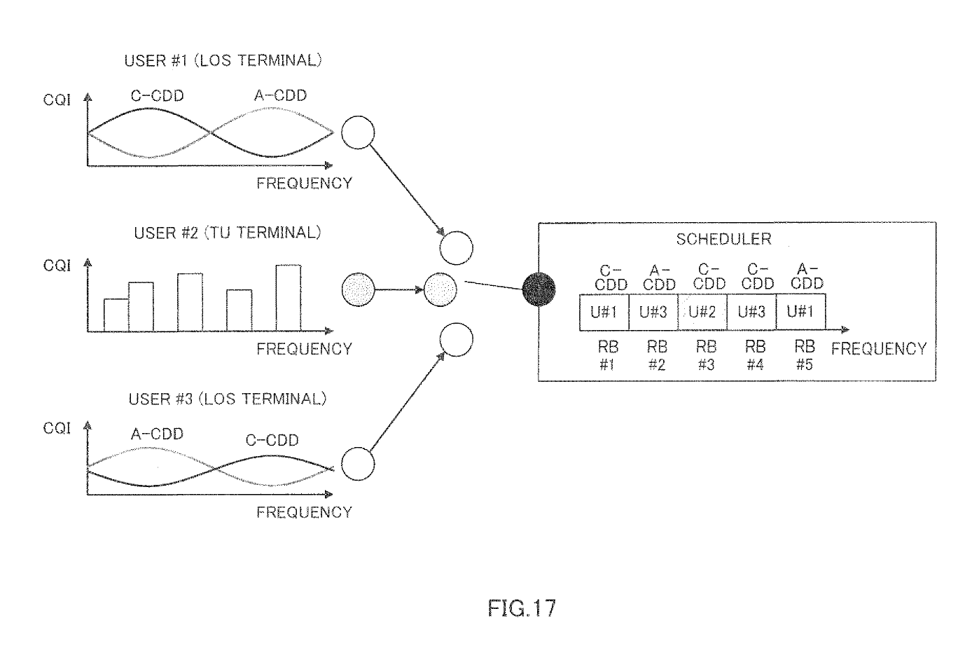

in the case of FIG. 17, although scheduling is performed for three users using CQI's corresponding to three channels in the prior art, user #1 and user #2 feed back two different channels, so that it is possible to schedule CQI's corresponding to five channels. By this means, it is possible to virtually increase the number of terminals, thereby improving sector throughput.

Referring to FIG. 17, RB #1 and RB #5 are allocated to user #1, which is an LOS terminal. The CDD matrix used in cyclic delay sections 502-1 and 502-2 is C-CDD in the case of RB #1 or A-CDD in the case of RB #2. Similarly, RB #2 and RB #4 are allocated to user #3, which is an LOS terminal. The CDD matrix used in cyclic delay sections 502-1 and 502-2 is A-CDD in the case of RB #3 or C-CDD in the ease of RB #4. On the other hand, RB #3 is allocated to user #2, which is a TU terminal. The TU terminal performs a best-M report, and therefore the CDD matrix used in cyclic delay sections 502-1 and 502-2 is C-CDD, Scheduling section 501 needs to output CDD information used for terminals to which communication resources (i.e. RB's) are allocated, to cyclic delay sections 502-1 and 502-2.

Cyclic delay sections 502-1 and 502-2 give a cyclic delay shift to symbols outputted from precoding section 306, using a C-CDD matrix or A-CDD matrix included in a control signal outputted form scheduling section 501. That is, cyclic delay sections 502-1 and 502-2 multiply an RB allocated to a TU terminal by the C-CDD matrix, and multiply RB's allocated to LOS terminals by the A-CDD matrix. The symbols given cyclic delay shifts are outputted to multiplexing sections 308-1 and 308-2.

Thus, according to Embodiment 2, an LOS terminal selects a DCT report and maps a CQI corresponding to A-CDD (i.e. A-CQI) that provides a different phase or angular velocity from C-CDD, so that it is possible to virtually increase the number of terminals and improve throughput.

### Embodiment 3

Although a case has been described with Embodiment 2 where C-CQI's and A-CQI's are fed back from a terminal to a base station, a case will be explained with Embodiment 3 where only C-CQI's are fed back from a terminal to a base station.

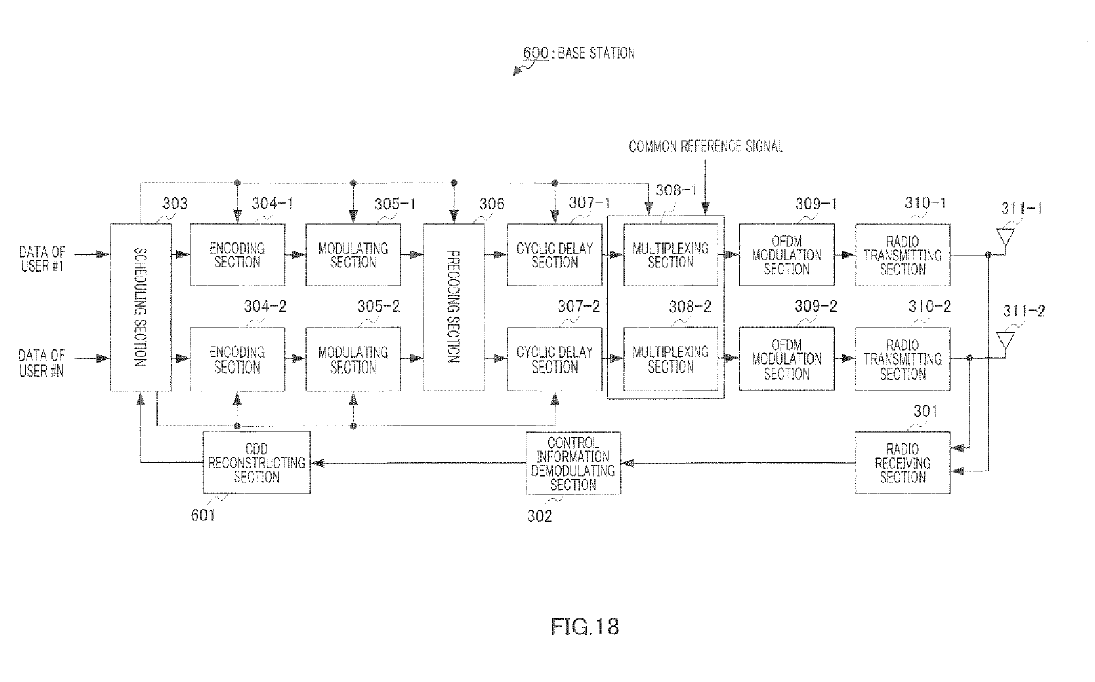

The configuration of a terminal according to Embodiment 3 of the present invention is the same as the configuration shown in FIG. 3 of Embodiment 1, and will be explained using FIG. 3. Also, the configuration of base station 600 according to Embodiment 3 of the present invention will be explained using FIG. 18. FIG. 18 differs from FIG. 16 in adding CDD reconstructing section 601.

If CQI feedback information outputted from control information demodulating section 302 indicates an LOS terminal, CDD reconstructing section 601 estimates A-CQI's based on C-CQI's included in the CQI feedback information, and outputs the A-CQI's to scheduling section 303.

Although there are two patterns of relationships between C-CDD and A-CDD, that is, there are two cases where a phase varies between C-CDD and A-CDD and where an angular velocity varies between C-CDD and A-CDD, a case will be explained below where a phase varies between C-CDD and A-CDD.

When the phase varies between C-CDD and A-CDD, the phase of A-CDD is shifted by π from the phase of C-CDD. That is, A-CQI's are estimated such that C-CQI's and A-CQI's are symmetric with respect to the average CQI of the entire band. Specifically explaining with reference to above FIG. 10, A-CQI's are estimated such that the CQI's for communication resources located in the C-CQI valley parts match the A-CQI peak parts, and the CQI's for communication resources located in the C-CQI peak parts match the A-CQI valley parts.

Thus, according to Embodiment 3, even in the case of feeding back only C-CQI's from a terminal to a base station, the base station can estimate A-CQI's and virtually increase the number of terminals, so that it is possible to improve the throughput.

Although a case has been described with the above embodiments as an example where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-318453, filed on Dec. 10, 2007, including the specification, drawings and abstract, is incorporated herein by reference in its entirety.

### INDUSTRIAL APPLICABILITY

The wireless communication apparatus, wireless communication base station apparatus and CQI feedback method according to the present invention can reduce feedback overhead and improve the reconstructibility of CQI's, and are applicable to mobile communication systems, for example.

1. A wireless communication terminal apparatus comprising:
a channel detecting section that detects whether a current channel environment is a channel environment of high frequency selectivity or a channel environment of low frequency selectivity;
a feedback channel quality indicator determining section that: when the channel environment of high frequency selectivity is detected, selects a best-M report method for feeding back channel quality indicators of top M channel quality indicator levels and an average channel quality indicator of all channel quality indicator levels; when the channel environment of low frequency selectivity is detected, selects a discrete cosine transform report method for feeding back a direct current component and (M−1) amplitude components of lower frequency components, in discrete cosine transform conversion results of a channel quality indicator; and determines a channel quality indicator to feed back according to the selected report method; and
a transmitting section that feeds back the determined channel quality indicator to a wireless communication base station apparatus.

2. The wireless communication terminal apparatus according to claim 1, wherein, when the discrete cosine transform report method is selected, the feedback channel quality indicator determining section determines a channel quality indicator which is to feed back using a produced available resource and which corresponds to a different channel from a channel for the determined channel quality indicator.

3. The wireless communication terminal apparatus according to claim 1, wherein, when the discrete cosine transform report method is selected, the feedback channel quality indicator determining section determines channel quality indicators corresponding to different channels formed using a first cyclic delay diversity and a second cyclic delay diversity different from the first cyclic delay diversity.

4. The wireless communication terminal apparatus according to claim 3, wherein the second cyclic delay diversity differs from the first cyclic delay diversity in a phase of a weight by which subcarriers are multiplied.

5. The wireless communication terminal apparatus according to claim 3, wherein the second cyclic delay diversity differs from the first cyclic delay diversity in an angular velocity of a weight by which subcarriers are multiplied.

6. The wireless communication terminal apparatus according to claim 2, wherein, when channel quality indicators of a plurality of channels, between which an average reception power difference stays within a predetermined range, are fed back simultaneously, the feedback channel quality indicator determining section makes the channel quality indicators of the channels share the direct current components in discrete cosine transform output results of the channel quality indicators of the channels.

7. The wireless communication terminal apparatus according to claim 6, wherein the feedback channel quality indicator determining section makes the channel quality indicators of different channels share the direct current components in discrete cosine transform output results of the channel quality indicators, the channel quality indicators corresponding to the channels formed using a first cyclic delay diversity and a second cyclic delay diversity different from the first cyclic delay diversity.

8. A wireless communication base station apparatus comprising:
a receiving section that receives a first channel quality indicator corresponding to a channel formed using a first cyclic delay diversity, by a discrete cosine transform report method for feeding back M amplitude components of lower frequency components in discrete cosine transform conversion results of channel quality indicators; and
a reconstructing section that reconstructs a second channel quality indicator corresponding to a channel formed using a second cyclic delay diversity different from the first cyclic delay diversity, based on the first channel quality indicator.

9. A channel quality indicator feedback method comprising:
a channel detecting step of detecting whether a current channel environment is a channel environment of high frequency selectivity or a channel environment of low frequency selectivity; and
a feedback channel quality indicator determining step of: when the channel environment of high frequency selectivity is detected, selecting a best-M report method for feeding back channel quality indicators of top M channel quality indicator levels and an average channel quality indicator of all channel quality indicator levels; when the channel environment of low frequency selectivity is detected, selecting a discrete cosine transform report method for feeding back a direct current component and (M−1) amplitude components of lower frequency components, in discrete cosine transform conversion results of channel quality indicators; and determining a channel quality indicator to feed back according to the selected report method.
